(19) United States
(12) Patent Application Publication
(10) Pub. No.: US 2023/0325852 A1
(43) Pub. Date: Oct. 12, 2023

(54) METHOD AND SYSTEM FOR AUTOMATION OF DUE DILIGENCE

(71) Applicant: JPMorgan Chase Bank, N.A., New York, NY (US)

(72) Inventors: Zhiqiang MA, Short Hills, NJ (US); Nacho NAVARRO, Storrs, CT (US); Charese SMILEY, Bristol, WI (US); Natraj RAMAN, London (GB); Petr BABKIN, Brooklyn, NY (US); William WATSON, Long Beach, NY (US); Elham Ghazizadeh AHSAEI, Manhattan, NY (US); Suchetha SIDDAGANGAPPA, Brooklyn, NY (US); Russell KOCIUBA, Rochester, NY (US); Steven POMERVILLE, Marion, NY (US); Robert D. MARTIN, Rochester, NY (US); Lawrence YONG, Harrison, NJ (US); Andrea STEFANUCCI, Hoboken, NJ (US); Armineh NOURBAKHSH, Pittsburgh, PA (US); Sameena SHAH, Scarsdale, NY (US)

(73) Assignee: JPMorgan Chase Bank, N.A., New York, NY (US)

(21) Appl. No.: 17/658,383

(22) Filed: Apr. 7, 2022

(51) Int. Cl. G06Q 30/02; G06Q 30/00

(52) U.S. Cl. CPC G06Q 30/0201; G06Q 30/018

(57) ABSTRACT

A method and a system for automating a due diligence process are provided. The method includes: receiving identification information that relates to a customer; selecting, from a global set of due diligence questions based on the received identification information, a group of due diligence questions to be applied to the customer; determining a document source via which documents containing relevant information about the customer are accessible; retrieving, from the document source, a set of documents that relate to the potential customer; extracting, from the retrieved documents, information that is relevant to the selected group of due diligence questions with respect to the customer; and outputting the extracted information. Each of the determination of the document source, the retrieval of the set of documents, and the extraction of the relevant information is performed automatically by executing artificial intelligence algorithms that implement machine learning techniques.

### BACKGROUND

### 1. Field of the Disclosure

This technology generally relates to methods and systems for performing due diligence, and more particularly to methods and systems for automating a due diligence process for onboarding new customers with respect to Know Your Customer (KYC) procedures and regulatory requirements.

### 2. Background Information

In large financial institutions, on an ongoing basis, business relationships with numerous clients and customers are established. From a regulatory perspective, there are legal requirements that each customer be thoroughly reviewed in order to ensure that the services to be provided to them are not used for illegal or inappropriate purposes. In addition to mitigating risk, doing research about customers allows for improved understanding of each customer, thereby enabling a provision of services that are better tailored to the needs of each respective customer. This process of research is known as KYC (Know Your Customer).

Conventionally, a dedicated KYC team is designated for handling operations related to the KYC process for wholesale customers. The review process may be referred to as a “lifecycle” event. Once a client undergoes an onboarding lifecycle, they are assigned a risk score. Depending on the risk score, they may be reviewed again on a regular basis—for example, a high-risk client may be reviewed several times. These reviews may be referred to as periodic reviews. In addition to periodic lifecycles, the client may also be reviewed in the event of major triggers, such as a change in management, changes in corporate structure, business expansions, acquisitions and/or mergers, issuance of new services, and/or major news events. The latter type of lifecycles are known as event-driven reviews.

Each lifecycle may involve a complicated review process, which includes two parts. In the first part, a group of KYC officers investigate a set of questions for which answers are required. This group collects documents that they suspect may include answers to those questions. They will then use those documents to find answers to the questions. In the second step, a different group of KYC officers double-check the answers to make sure they have been properly sourced and addressed.

Conventionally, customers serviced by a wholesale line of business may be classified into one of the following categories: corporations (including publicly traded companies and/or privately held corporations); non-operating/asset holding (NOAH) companies; funds; banks; non-banking financial institutions (NBFI); government agencies; and other/unconventional.

The universe of all questions that require answers may exceed thousands of questions. However, depending on the type and risk rating of the customer, typically, a subset of this universal question set is applicable to any particular customer.

Local due diligence (LDD) is one of the most challenging segments of the KYC questionnaire. Each customer might book services through various branches around the world which may be referred to as booking locations. The booking location that a customer has engaged with determine the set of applicable LDD requirements. For example, a customer who has booked services through New York and London branches may only need to undergo LDD for Great Britain, in addition to standard due diligence imposed within the USA. However, some booking locations have very complicated LDD requirements, and for some of them sourcing information may be more difficult.

Because of the pervasiveness of the KYC questionnaire and the ongoing nature of the due diligence process, there are significant costs relating to resource usage and availability. In particular, the number of human employees that are required for performing the due diligence process is quite large, potentially in the hundreds or thousands. Accordingly, there is a need for a mechanism for automating a due diligence process for onboarding new customers with respect to Know Your Customer (KYC) procedures and regulatory requirements in a reliable and efficient manner, in order to reduce human effort and cost.

### SUMMARY

The present disclosure, through one or more of its various aspects, embodiments, and/or specific features or sub-components, provides, inter alia, various systems, servers, devices, methods, media, programs, and platforms for automating a due diligence process for onboarding new customers with respect to Know Your Customer (KYC) procedures and regulatory requirements.

According to an aspect of the present disclosure, a method for performing a due diligence process is provided. The method is implemented by at least one processor. The method includes: receiving, by the at least one processor, identification information that relates to a first customer; selecting, from a predetermined global set of due diligence questions by the at least one processor based on the received identification information, a first group of due diligence questions to be applied to the first customer; determining, by the at least one processor, a document source via which documents containing relevant information about the first customer are accessible; retrieving, by the at least one processor from the document source, a first set of documents that relate to the first customer; extracting, by the at least one processor from the first set of documents, information that is relevant to the selected first group of due diligence questions with respect to the first customer; and outputting, by the at least one processor, the extracted information.

The selecting of the first group of due diligence questions may include applying, to the received identification information, a first artificial intelligence algorithm that implements a machine learning technique and is trained by using historical data that relates to an applicability of each of the predetermined global set of due diligence questions to respective customers.

The determining of the document source may include applying, to the received identification information, a second artificial intelligence algorithm that implements a machine learning technique and is trained by using historical document sourcing data.

The retrieving of the first set of documents may include applying the second artificial intelligence algorithm to the determined document source in order to identify each document included in the first set of documents.

The extracting may include applying, to the first set of documents, a third artificial intelligence algorithm that implements a machine learning technique and is trained by using historical semantic search data, in order to detect the information that is relevant to the selected first group of due diligence questions with respect to the first customer from within the first set of documents.

The method may further include outputting at least one from among an output of the second artificial intelligence algorithm and an output of the third artificial intelligence algorithm that includes explanatory information that is usable for verifying at least one from among an accuracy and a reliability of the extracted information.

The method may further include displaying, via a graphical user interface (GUI), the extracted information and the explanatory information.

The identification information may include type information that relates to a type of the first customer. The type information may include at least one from among a first type that relates to a publicly traded corporation, a second type that relates to a privately held corporation, a third type that relates to a non-operating/asset holding company, a fourth type that relates to a fund, a fifth type that relates to a bank, a sixth type that relates to a non-banking financial institution, a seventh type that relates to a governmental agency, and/or other suitable types.

The predetermined global set of due diligence questions may include a plurality of subsets of questions, such as a first subset of questions that relate to customer due diligence, a second subset of questions that relate to a customer identification program, a third subset of questions that relate to account due diligence, a fourth subset of questions that relate to product and service due diligence, a fifth subset of questions that relate to related parties, a sixth subset of questions that relate to customer ownership, a seventh subset of questions that relate to screenings and sanctions, and an eighth subset of questions that relate to financial crimes and anti-money laundering and other risks.

According to another aspect of the present disclosure, a computing apparatus for performing a due diligence process is provided. The computing apparatus includes a processor; a memory; and a communication interface coupled to each of the processor and the memory. The processor is configured to: receive, via the communication interface, identification information that relates to a first customer; select, from a predetermined global set of due diligence questions based on the received identification information, a first group of due diligence questions to be applied to the first customer; determine a document source via which documents containing relevant information about the first customer are accessible; retrieve, from the document source, a first set of documents that relate to the first customer; extract, from the first set of documents, information that is relevant to the selected first group of due diligence questions with respect to the first customer; and output the extracted information.

The processor may be further configured to select the first group of due diligence questions by applying, to the received identification information, a first artificial intelligence algorithm that implements a machine learning technique and is trained by using historical data that relates to an applicability of each of the predetermined global set of due diligence questions to respective customers.

The processor may be further configured to determine the document source by applying, to the received identification information, a second artificial intelligence algorithm that implements a machine learning technique and is trained by using historical document sourcing data.

The processor may be further configured to retrieve the first set of documents by applying the second artificial intelligence algorithm to the determined document source in order to identify each document included in the first set of documents.

The processor may be further configured to perform the extraction by applying, to the first set of documents, a third artificial intelligence algorithm that implements a machine learning technique and is trained by using historical semantic search data, in order to detect the information that is relevant to the selected first group of due diligence questions with respect to the first customer from within the first set of documents.

The processor may be further configured to output at least one from among an output of the second artificial intelligence algorithm and an output of the third artificial intelligence algorithm that includes explanatory information that is usable for verifying at least one from among an accuracy and a reliability of the extracted information.

The processor may be further configured to display, via a graphical user interface (GUI), the extracted information and the explanatory information.

The identification information may include type information that relates to a type of the first customer. The type information may include at least one from among a first type that relates to a publicly traded corporation, a second type that relates to a privately held corporation, a third type that relates to a non-operating/asset holding company, a fourth type that relates to a fund, a fifth type that relates to a bank, a sixth type that relates to a non-banking financial institution, and a seventh type that relates to a governmental agency.

The predetermined global set of due diligence questions may include a plurality of subsets of questions, such as a first subset of questions that relate to customer due diligence, a second subset of questions that relate to a customer identification program, a third subset of questions that relate to account due diligence, a fourth subset of questions that relate to product and service due diligence, a fifth subset of questions that relate to related parties, a sixth subset of questions that relate to customer ownership, a seventh subset of questions that relate to screenings and sanctions, and an eighth subset of questions that relate to financial crimes and anti-money laundering and other risks.

According to yet another aspect of the present disclosure, a non-transitory computer readable storage medium storing instructions for performing a due diligence process is provided. The storage medium includes executable code which, when executed by a processor, causes the processor to: receive identification information that relates to a first customer; select, from a predetermined global set of due diligence questions based on the received identification information, a first group of due diligence questions to be applied to the first customer; determine a document source via which documents containing relevant information about the first customer are accessible; retrieve, from the document source, a first set of documents that relate to the first customer; extract, from the first set of documents, information that is relevant to the selected first group of due diligence questions with respect to the first customer; and output the extracted information.

When executed, the executable code may further cause the processor to select the first group of due diligence questions by applying, to the received identification information, a first artificial intelligence algorithm that implements a machine learning technique and is trained by using historical data that relates to an applicability of each of the predetermined global set of due diligence questions to respective customers.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automating a due diligence process for onboarding new customers with respect to Know Your Customer (KYC) procedures and regulatory requirements.

FIG. 4 is a flowchart of an exemplary process for implementing a method for automating a due diligence process for onboarding new customers with respect to KYC procedures and regulatory requirements.

FIG. 5 is a diagram that illustrates a process of parsing a portable document format (PDF) document as part of a method for automating a due diligence process for onboarding new customers with respect to KYC procedures and regulatory requirements, according to an exemplary embodiment.

FIG. 6 is a diagram that illustrates a table recognition overview as part of a method for automating a due diligence process for onboarding new customers with respect to KYC procedures and regulatory requirements, according to an exemplary embodiment.

FIG. 7 is a flowchart that illustrates a document classification process as part of a method for automating a due diligence process for onboarding new customers with respect to KYC procedures and regulatory requirements, according to an exemplary embodiment.

FIG. 8 is a diagram that illustrates a KYC process as part of a method for automating a due diligence process for onboarding new customers with respect to KYC procedures and regulatory requirements, according to an exemplary embodiment.

FIG. 9 is a screenshot of a graphical user interface for entering a search input as part of a method for automating a due diligence process for onboarding new customers with respect to KYC procedures and regulatory requirements, according to an exemplary embodiment.

FIG. 10 is a screenshot of a graphical user interface for showing document search results as part of a method for automating a due diligence process for onboarding new customers with respect to KYC procedures and regulatory requirements, according to an exemplary embodiment.

FIG. 11 is a screenshot of a graphical user interface for showing a document view as part of a method for automating a due diligence process for onboarding new customers with respect to KYC procedures and regulatory requirements, according to an exemplary embodiment.

FIG. 12 is a screenshot of a graphical user interface for showing a document upload functionality as part of a method for automating a due diligence process for onboarding new customers with respect to KYC procedures and regulatory requirements, according to an exemplary embodiment.

FIG. 13 is a screenshot of a graphical user interface for showing a document pinning functionality as part of a method for automating a due diligence process for onboarding new customers with respect to KYC procedures and regulatory requirements, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

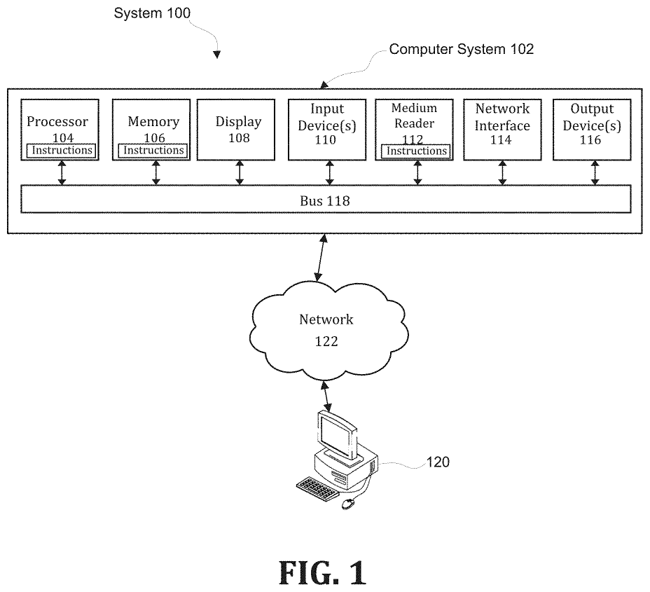

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automating a due diligence process for onboarding new customers with respect to Know Your Customer (KYC) procedures and regulatory requirements.

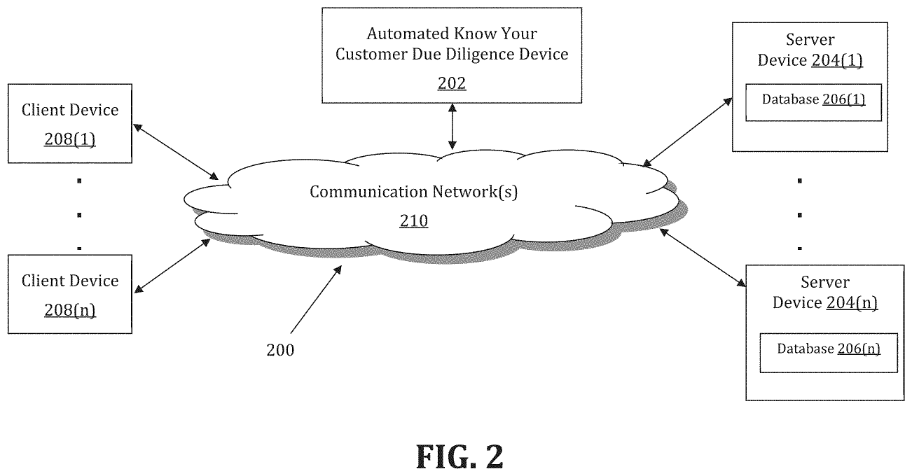

Referring to FIG. 2, a schematic of an exemplary network environment 200 for implementing a method for automating a due diligence process for onboarding new customers with respect to KYC procedures and regulatory requirements is illustrated. In an exemplary embodiment, the method is executable on any networked computer platform, such as, for example, a personal computer (PC).

The method for automating a due diligence process for onboarding new customers with respect to KYC procedures and regulatory requirements may be implemented by an Automated Know Your Customer Due Diligence (AKYCDD) device 202. The AKYCDD device 202 may be the same or similar to the computer system 102 as described with respect to FIG. 1. The AKYCDD device 202 may store one or more applications that can include executable instructions that, when executed by the AKYCDD device 202, cause the AKYCDD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AKYCDD device 202 itself, may be located in virtual server(s) running in a cloud-based computing environment rather than being tied to one or more specific physical network computing devices. Also, the application(s) may be running in one or more virtual machines (VMs) executing on the AKYCDD device 202. Additionally, in one or more embodiments of this technology, virtual machine(s) running on the AKYCDD device 202 may be managed or supervised by a hypervisor.

In the network environment 200 of FIG. 2, the AKYCDD device 202 is coupled to a plurality of server devices 204(1)-204(n) that hosts a plurality of databases 206(1)-206(n), and also to a plurality of client devices 208(1)-208(n) via communication network(s) 210. A communication interface of the AKYCDD device 202, such as the network interface 114 of the computer system 102 of FIG. 1, operatively couples and communicates between the AKYCDD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AKYCDD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AKYCDD devices that efficiently implement a method for automating a due diligence process for onboarding new customers with respect to KYC procedures and regulatory requirements.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AKYCDD device 202 may be a standalone device or integrated with one or more other devices or apparatuses, such as one or more of the server devices 204(1)-204(n), for example. In one particular example, the AKYCDD device 202 may include or be hosted by one of the server devices 204(1)-204(n), and other arrangements are also possible. Moreover, one or more of the devices of the AKYCDD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AKYCDD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to contents of KYC questionnaires and data that relates to customer-specific due diligence information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AKYCDD device 202 via communication network(s) 210. Accordingly, the client devices 208(1)-208(n) may be mobile computing devices, desktop computing devices, virtual computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AKYCDD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AKYCDD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AKYCDD device 202, the server devices 204(1)-204(n), or the client devices 208(1)-208(n), for example, may be configured to operate as virtual instances on the same physical machine. In other words, one or more of the AKYCDD device 202, the server devices 204(1)-204(n), or the client devices 208(1)-208(n) may operate on the same physical device rather than as separate devices communicating through communication network(s) 210. Additionally, there may be more or fewer AKYCDD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

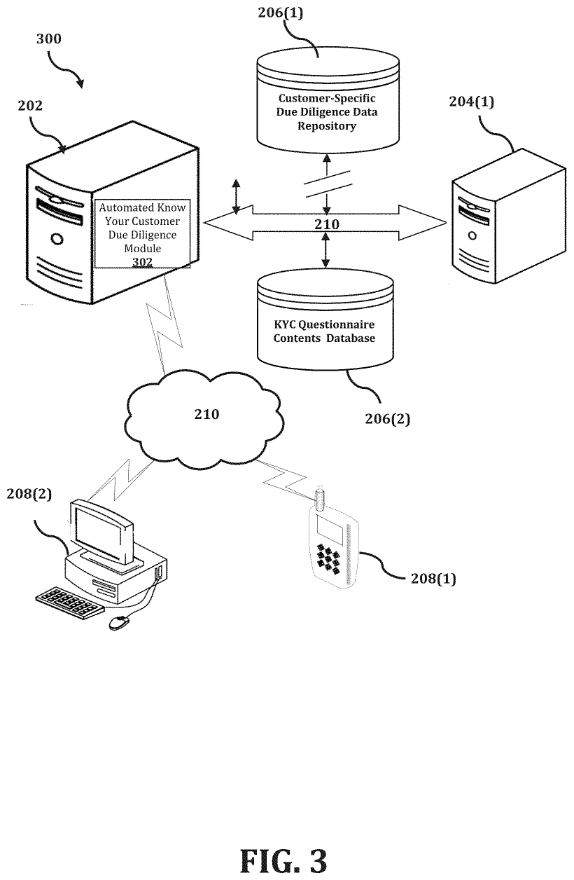

The AKYCDD device 202 is described and illustrated in FIG. 3 as including an automated Know Your Customer due diligence module 302, although it may include other rules, policies, modules, databases, or applications, for example. As will be described below, the automated Know Your Customer due diligence module 302 is configured to implement a method for automating a due diligence process for onboarding new customers with respect to KYC procedures and regulatory requirements.

An exemplary process 300 for implementing a mechanism for automating a due diligence process for onboarding new customers with respect to KYC procedures and regulatory requirements by utilizing the network environment of FIG. 2 is illustrated as being executed in FIG. 3. Specifically, a first client device 208(1) and a second client device 208(2) are illustrated as being in communication with AKYCDD device 202. In this regard, the first client device 208(1) and the second client device 208(2) may be “clients” of the AKYCDD device 202 and are described herein as such. Nevertheless, it is to be known and understood that the first client device 208(1) and/or the second client device 208(2) need not necessarily be “clients” of the AKYCDD device 202, or any entity described in association therewith herein. Any additional or alternative relationship may exist between either or both of the first client device 208(1) and the second client device 208(2) and the AKYCDD device 202, or no relationship may exist.

Further, AKYCDD device 202 is illustrated as being able to access a customer-specific due diligence data repository 206(1) and a KYC questionnaire contents database 206(2). The automated Know Your Customer due diligence module 302 may be configured to access these databases for implementing a method for automating a due diligence process for onboarding new customers with respect to KYC procedures and regulatory requirements.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AKYCDD device 202 via broadband or cellular communication. Of course, these embodiments are merely exemplary and are not limiting or exhaustive.

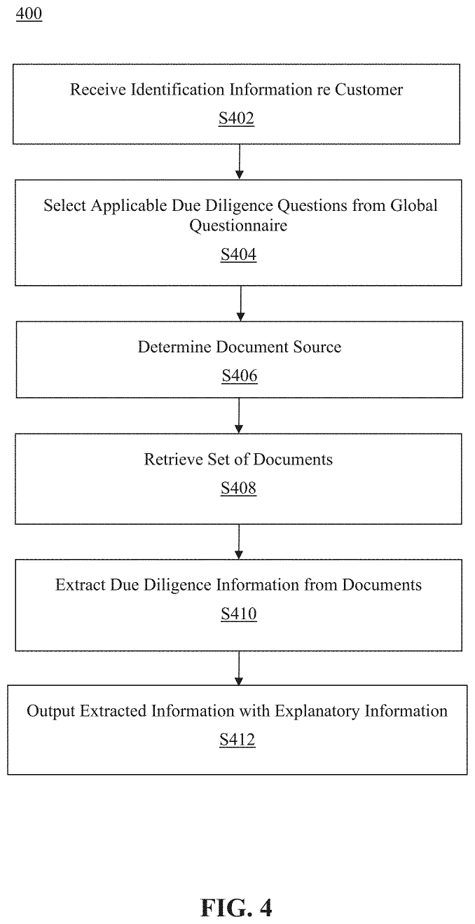

Upon being started, the automated Know Your Customer due diligence module 302 executes a process for automating a due diligence process for onboarding new customers with respect to KYC procedures and regulatory requirements. An exemplary process for automating a due diligence process for onboarding new customers with respect to KYC procedures and regulatory requirements is generally indicated at flowchart 400 in FIG. 4.

In process 400 of FIG. 4, at step S402, the automated Know Your Customer due diligence module 302 receives identification information that relates to a customer. The customer may be a potential customer with which a commercial relationship has not yet been established, a new customer that is being onboarded for the first time, or an established customer with which a commercial relationship has been ongoing. In an exemplary embodiment, the identification information includes type information that indicates a type of the customer. For example, the type information may include any of the following: a first type that relates to a publicly traded corporation, a second type that relates to a privately held corporation, a third type that relates to a non-operating/asset holding (NOAH) company, a fourth type that relates to a fund, a fifth type that relates to a bank, a sixth type that relates to a non-banking financial institution, and/or a seventh type that relates to a governmental agency.

At step S404, the automated Know Your Customer due diligence module 302 selects applicable due diligence questions from a predetermined global set of due diligence questions. In an exemplary embodiment, the predetermined global set of due diligence questions includes a first subset of questions that relate to customer due diligence, a second subset of questions that relate to a customer identification program, a third subset of questions that relate to account due diligence, a fourth subset of questions that relate to product and service due diligence, a fifth subset of questions that relate to related parties, a sixth subset of questions that relate to customer ownership, a seventh subset of questions that relate to screenings and sanctions, and an eighth subset of questions that relate to financial crimes and anti-money laundering and other risks.

The number of questions included in the global set may exceed one thousand (1000) and may range as high as ten thousand (10,000) or more. The number of selected questions as being applicable to a particular customer may be on the order of hundreds, such as, for example, between one hundred (100) and five hundred (500). In an exemplary embodiment, the selecting of applicable questions may be performed by applying, to the identification information received in step S402, a first artificial intelligence (AI) algorithm that implements a machine learning (ML) technique and is trained by using historical data that relates to an applicability of each of the predetermined global set of due diligence questions to respective customers.

At step S406, the automated Know Your Customer due diligence module 302 determines a document source via which documents containing relevant information about the customer are accessible. In an exemplary embodiment, the determining of the document source may be implemented by applying, to the identification information received in step S402, a second AI algorithm that implements an ML technique and is trained by using historical document sourcing data. In this aspect, the second AI algorithm may function as a source recommendation engine. The second AI algorithm may also generate explanatory information that relates to how and why the determined document source is deemed as a useful source with respect to a particular customer.

At step S408, the automated Know Your Customer due diligence module 302 retrieves a set of documents that relate to the customer from the document source determined in step S406. In an exemplary embodiment, the retrieving of the documents may be performed by applying the second AI algorithm to the determined document source in order to identify each document included in the document set. The second AI algorithm may also generate additional explanatory information that relates to how and why each retrieved document is deemed as relevant to a particular customer.

At step S410, the automated Know Your Customer due diligence module 302 extracts information that is relevant to the questions selected in step S404 with respect to the customer. In an exemplary embodiment, the extraction may include applying, to the set of documents retrieved in step S408, a third AI algorithm that implements an ML technique and is trained by using historical semantic search data, in order to detect the relevant information. The third AI algorithm may also generate further explanatory information that relates to the relevance of the extracted information with respect to a particular customer.

At step S412, the automated Know Your Customer due diligence module 302 outputs the extracted information, together with at least a portion of the explanatory information generated by the AI algorithms. In an exemplary embodiment, the extracted information and/or the explanatory information is displayable via a graphical user interface (GUI) that may be accessed by a user, in order to facilitate a verification that the extracted information is accurate, complete, and reliable. In this manner, such a user may be able to confirm that a successful due diligence operation is complete with respect to a particular customer.

The legal term “due diligence” refers to the process of qualifying an entity for certain engagements, such as a business transaction. One example is KYC due diligence, which requires businesses to perform thorough research on all customers with whom they intend to conduct business. The customer may be an individual, a business entity, or an individual affiliated with a business entity. Due diligence entails the collection of all relevant documentation and information about the customer, and using the collected documentation and information to answer a standard set of questions. In an exemplary embodiment, the answers to these questions may determine any one or more of the following: 1) whether the customer is legally qualified to do business with the business for whom the due diligence is being performed; 2) which types of business engagements are allowed; 3) what are the risks associated with the customer; and 4) how often does the customer need to be reviewed and what events trigger a reassessment.

For example, as a provision of the USA Patriot Act, financial institutions need to verify the identities of their customers by filling out a questionnaire known as the Customer Identification Program (CIP). The CIP includes questions such as name, address, tax ID number, and other requirements related to an entity's identity. Additionally, financial institutions need to ensure that the services they provide to their customers are not used for illegal or illicit activities. This can be carried out by monitoring the customer's transactions and identifying whether their behavior deviates from expectations. Finally, the institutions need to ensure that the customer is qualified to receive all products and services provided to them. Further, depending on the customer's country of domicile or the jurisdiction within which they interact with the financial institution, additional regulatory and due diligence requirements may be applicable.

As is expected, due diligence can quickly grow into a complex and highly involved process. It is common for businesses to incur substantial operational costs in the course of manually reviewing and approving customers. The costs may be further compounded by the fact that each customer should undergo due diligence for all of the following occasions: 1) during onboarding; 2) periodically, as determined by the level of risk (e.g., a high-risk customer might need to be reviewed and re-qualified several times a year); 3) upon engaging in any new business activity; 4) in the event of a significant change in the customer's organization or ownership structure; 5) when a business inquiry is opened in a new jurisdiction; 6) if a substantial news story breaks about the customer, such as a change in management or a scandal; 7) if certain triggers are activated, e.g., the customer's transactional activity exhibits a sudden change or exceeds expectations; and 8) during offboarding.

In an exemplary embodiment, the present disclosure describes a fully automated system that can monitor clients, collect all relevant information about them at the point of necessity, and satisfy all due diligence requirements. The system uses a sophisticated pipeline for sourcing and storing the data, and making it available to end users. To answer all relevant due diligence questions, the system uses Machine Learning, Natural Language Processing, and Computer Vision models.

Table 1 below provides examples of due diligence requirements based on whether each respective answer often appears in text, tables, or graphics, and whether the each respective answer can be directly extracted, inferred, or requires multi-step reasoning.

TABLE 1

| | Text | Tables | Graphics |
|---|---|---|---|
| Direct | Ticker | Physical | Name of ultimate |
| | symbol. | address. | parent. |
| Inferred | Country of | Total | If parent is |
| (single-hop) | registration. | revenue. | publicly traded. |
| Inferred | Industry | Countries of | List of beneficial |
| (multi-hop) | classification. | significant | owners. |
| | | operations. | |

The first row of Table 1 shows requirements with the lowest level of complexity. Given an exchange registration form, a simple information extraction algorithm can be used to identify the ticker symbol. Physical addresses are also often easy to extract. However, extracting the physical addresses might require additional spatial reasoning over tables. Given an organizational tree, the name of a client's ultimate parent can be identified by extracting the name of the entity that is at the root of the tree.

The second row of Table 1 displays requirements that require one-step (also referred to herein as “one-hop”) reasoning to satisfy. Given a state registration form, it is not always possible to directly identify the corresponding country of registration. For instance, within the United States of America (USA), only the state of registration may be mentioned. The system needs to first identify the state, then reason that the state is located within the USA. Similarly, to calculate the total revenue of a client, the system may need to identify individual revenue streams in a table and then sum up the revenue streams. To answer whether the parent of a client is publicly traded, the system needs to first identify the parent in an organization chart, and then use a secondary source to verify whether it is publicly traded.

The last row of Table 1 shows requirements with the highest level of complexity. To infer the industry classification of a client, the system needs to understand all of its business practices, as described in its website or its financial disclosures. To identify significant operations, the system first needs to identify all operations in a financial table, then identify the revenue associated with each operation, and then determine which operations account for significant revenue, and lastly identify the countries associated with those operations. To identify the beneficial owners of a client, the system needs to understand complex ownership graphs and reason over them.

Data sourcing: The first step in many due diligence processes is to collect all relevant documentation about a client. For business clients, this could include any one or more of the following: 1) origination documents, such as articles of incorporation, registration forms, or other organizational disclosures; 2) financial filings and disclosures; 3) data on current activities, assets, products/services, clients, suppliers, and operations; 4) organizational hierarchy and ownership structure; 5) individuals and business entities affiliated therewith; 6) demographic information on those individuals; 7) any licenses or other regulatory requirements; and/or 8) local requirements, depending on the country of domicile or the country within which business is to be conducted.

The data may be sourced programmatically from various origins, including any one or more of the following: 1) application programming interfaces (APIs) or “Really Simple Syndication” (RSS) feeds provided by websites of government and regulatory bodies such as the Securities and Exchange Commission (SEC), exchange registrations, or state-level trade registrars; 2) APIs provided by third-party data aggregators and business intelligence services; 3) existing internal or external databases; 4) information on the client's website, curated using intelligent web scrapers; 5) regulatory forms such as the Wolfsberg questionnaire required to be submitted by banks in the U.K.; 6) documents provided directly by the client, e.g., government-issued identifications (IDs) of affiliated individuals; and/or 7) email communications with the client.

In an exemplary embodiment, the result of the data curation step is a collection of documents that are commonly in Portable Document Format (PDF). Some of the PDF documents may be properly formatted, but in many cases they may be scanned images, or of low quality. The following is a description of how to process these documents in a scalable fashion, how to extract important information from the documents, and how to persist the documents in an elastic search index.

Preprocessing—Asynchronous PDF parser. In an exemplary embodiment, the automated due diligence pipeline is a complicated process powered by many Machine Learning models in the Natural Language Processing (NLP) and Computer Vision (CV) domains. These models require both the underlying text in the PDF documents, as well as the position where each word occurs on the page. Often, these items can be extracted from the PDF itself if the text is machine-readable; that is, if the text is encoded in a stream in the PDF's source. In many cases, however, the text may be embedded as an image or a scan within the document, thus making the task of extracting both the text and its position challenging. This is especially common for legally binding documents that bear hand-written signatures, which compose a large part of due diligence documentation.

One way to resolve this issue is by using optical character recognition (OCR), a technique for converting text in images to machine-readable text that can be later stored and searched. A limiting factor in this approach is that the time taken for the conversion may be relatively long, and the volume of documents to be processed internally may be very high. As a result, the overall step of extracting the text for the models may be a bottleneck in the pipeline. To resolve this, in an exemplary embodiment, an asynchronous PDF parser that introduces parallelization both at the document level and at the page level for extremely fast text extraction may be utilized.

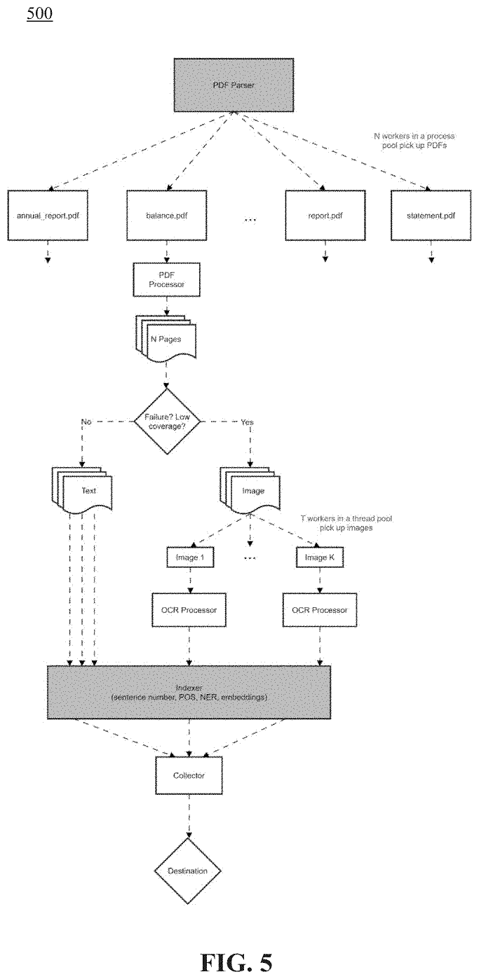

FIG. 5 is a diagram 500 that illustrates a process of parsing a portable document format (PDF) document as part of a method for automating a due diligence process for onboarding new customers with respect to KYC procedures and regulatory requirements, according to an exemplary embodiment. Referring to FIG. 5, the PDF parser works in a batch fashion whereby multiple PDFs can be parsed at the same time. As a first step, the engine spins up a pool of workers as subprocesses that consume each PDF in the batch. If there are more documents than workers available, a queue is formed and when a worker becomes idle, the PDF at the head of the queue is removed and processed by the worker. When a worker receives a PDF, it first spins up a pool of subworkers, this time as threads, that consume each page of the document. Once again, a queue is formed if there are more pages than idle threads.

When a thread receives a single page of the document, it first reads the machine-readable text and records it along with the bounding box of each word. Upon completion, it then needs to decide whether a second pass of OCR is needed to find further text embedded in an image. If the first pass detects a small number of words resulting in a low coverage, the engine decides that the page requires optical character recognition. It then triggers the OCR engine to find all the text on the page, discarding the first pass.

The resulting output is a tab-delimited file with several columns identifying each word on the page, its bounding-box coordinates, its line number, and its paragraph number. This file is further augmented by adding additional markers such as sentence numbers, named entity flags, and part-of-speech tags. In an exemplary embodiment, the additional markers are added by using the spaCy library.

In an exemplary embodiment, all pages are finally collated into one dataset, with optional formatting in a relational or hierarchical manner. In either case, the output contains a list of words with the information extracted for each word in the PDF, as shown in Table 2.

TABLE 2

| Field | Description |
|---|---|
| Text | The word itself |
| Width | Width in pixels of the |
| | bounding box of the word |
| Height | Height in pixels of the |
| | bounding box of the word |
| Left | Pixel offset where the |
| | bounding box starts horizontally |
| Top | Pixel offset where the |
| | bounding box starts vertically |
| Paragraph Number | Paragraph number of the page |
| Page Number | Page number where the |
| | word is located |
| Line Number | Line number of the paragraph |
| Word Number | Word number in the line |
| Confidence | A percentage of how confident the |
| | OCR is the word extracted is correct |
| Page Height | The height of the page where |
| | the word is located |
| Page Width | The width of the page where |
| | the word is located |
| Processor | Whether the word was machine- |
| | readable or OCR was needed |
| Sentence Number | Sentence number in the paragraph |

Table recognition: Documents often contain tabular format data in which information is arranged systematically in rows and columns to represent logical groups. The table structure may not be preserved in PDF/scanned documents, and as a result, they must be explicitly reconstructed from their visual layout. In an exemplary embodiment, a machine vision-based multi-stage ensemble algorithm that first detects the location of a table, identifies the granular cell regions and finally aggregates them into structured rows and columns is provided. The algorithm adaptively resolves the table structure based on document specific availability of visual cues. For instance, if well-defined borders are available to demarcate the table cells, then border hints are preferred over a borderless generic prediction.

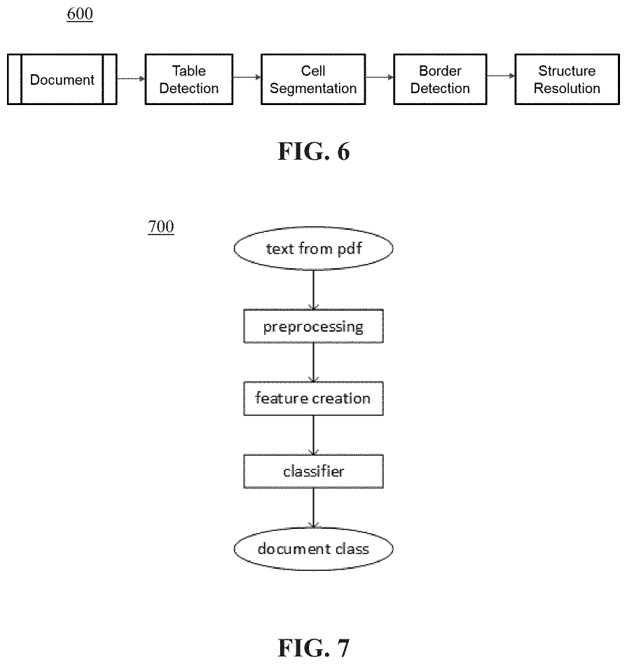

FIG. 6 is a diagram 600 that illustrates a table recognition overview as part of a method for automating a due diligence process for onboarding new customers with respect to KYC procedures and regulatory requirements, according to an exemplary embodiment. In order to identify the tables, a Deep Learning model that can distinguish tables in a document page from other layout elements such as figures, text or equations is developed. In addition to the table detection model, another Deep Learning model for cell detection is trained to segment the logical cells in a table. Concurrently, the horizontal and vertical strokes in a document page are identified by applying morphological operations, Hough transforms and connected component analysis. These strokes, if present, constitute the border lines that separate the cell regions. Finally, the spatial relations between the segmented cells are exploited to arrange the cells in a geometrically coherent manner. This produces a well-defined tabular structure with row and column numbers assigned to each cell. In an exemplary embodiment, when training the Deep Learning models, the real-world tables are augmented with synthetically generated tables in order to increase the data size and capture the wide diversity in tabular layouts.

Document classification: In an exemplary embodiment, the system collects multiple types of documents and processes the documents to collect desired information. Some information may be extracted from specific document types. For example, the full name of an entity should be identified and extracted from accredited documents such as state registries. In an exemplary embodiment, a document classification module is designed to recognize the type of the documents so as to apply appropriate models to process different document.

The document classification module takes the extracted text as an input. The text of the document is further processed to remove non-English characters and extra spaces. To build the classifier, a set of training documents are generated by labeling the documents with the corresponding types. Depending on the classifiers adopted, feature engineering such as TF-IDF matrix and stop-word removal may be required before training the classifiers. Mathematically, given a textual input d, a function ƒ may be learned in order to map d to a finite set of labels C ƒ:d→C. In an exemplary embodiment, multiple classifiers including neural network classifier, random forest, and logistic regression may be used to learn the function ƒ. FIG. 7 is a flowchart 700 that illustrates components of a document classification module as part of a method for automating a due diligence process for onboarding new customers with respect to KYC procedures and regulatory requirements, according to an exemplary embodiment.

Multimodal information extraction and reasoning—reasoning over text and tables. The levels of complexity to answer due diligence requirements may vary greatly. Simple requirements, such as a beneficiary's social security number, can be identified by matching textual patterns or information extraction from text documents. However, complex requirements, such as industry classification, might require understanding multiple documents together and inferring answers with multiple steps. In an exemplary embodiment, a reasoning system that combines different reasoning strategies based on the complexities of the requirements and also the formats of text is provided. A reasoning result from the system is an “Answer” object which includes several attributes—i.e., the string of the text, the page number where the answer is located, the bounding box coordinates of the answer on that page, and the confidence level (i.e., probability) of the prediction.

Pattern matching based extraction: There may be a few number and date fields in the due diligence requirements. As they often follow certain patterns, a regex matching method is an efficient solution to identify the predefined patterns. Those matched patterns from the text of PDF documents will act as answer candidates that will be selected as final answers by correlating with other fields.

For example, dates of birth of beneficial owners can be identified by regex matching. However, certain documents might mention multiple beneficial owners' personal information. To associate a date of birth candidate with its corresponding beneficial owner name, the spatial information between the candidate and the name may be leveraged by using a criterion that the location (coordinates) of the date must be behind or below the name within a predefined distance threshold. If a table structure is detected by using the technique described above, the date will be associated to the name in the same row or column.

Question answering based extraction: Many due diligence requirements do not follow any patterns and therefore cannot be solved by pattern matching, such as ticker symbols which are in different lengths and format. The answers for these types of requirements are often embedded in the text. To answer these questions, in an exemplary embodiment, a natural language processing (NLP) question answering (QA) system that is trained with historical data may be used.

In an exemplary embodiment, a training dataset may be built by using the historical answers. Each training sample is a triplet, consisting of a question string, an answer string, and a context string where the answer is found. The location information of the answer represented by the coordinates of its bounding box is also given as part of the training data.

Question answering on tabular data: Tabular data are very common in the due diligence documents, such as government registry documents of an entity and query results from third party data vendors. Some tables are bordered, while some are borderless. These documents are crucial data sources and must be digested in the reasoning process. A significant portion of CIP data are extractable from government registries.

In an exemplary embodiment, an approach to build training data for QA system on tabular data is provided. With the coordinates of the cells, cells can be aligned into rows and columns. The text of cells in the same row or column is concatenated as a text segment. The text segment will then serve as the context component of the triplet in the training dataset instead of the row text provided by the OCR process.

Reasoning over graphics: Answers to many KYC questions are expressed in schematic form rather than text. For example, an ownership structure diagram may encode complex relations among parent companies and their subsidiaries, as well as the degrees of ownership. Relying on the text—such as company names and percentages alone, in order to derive the share of ownership with respect to the client, may be insufficient, since the answer often requires derivation from multiple values and may require the understanding of structural connections among entities to be properly computed. In an exemplary embodiment, multimodal deep learning models that combine efficient visual representations with layout-aware contextual text embeddings may be employed for diagram question answering (DQA). The answer is produced by the model's attention mechanism, by focusing on regions of interest (ROI) in the image that are relevant to the posed question.

Calibration and explanation: In an exemplary embodiment, the result of the above description is an automated system that uses various Machine Learning techniques to predict the answers to due diligence questions. Although this automated due diligence system is comprised of a number of models that operate at the question-level or field-level, it is important to consider the entire set of outputs for a record holistically.

Due Diligence Errors: The types of errors that may occur can be broken up into several categories: human and AI system depending on the origin of the error. Table 3 (below) shows common types of errors that occur when satisfying due diligence requirements. Using automated due diligence, certain types of defects may be avoided, such as spelling errors and leaving records incomplete by missing values or not attaching files as required. Conversely, automated systems are subject to less flexibility in interpreting unusual or poorly formatted PDF inputs as well as understanding situations when special circumstances may apply. Both humans and AI systems are subject to selecting the wrong document or supplying inconsistent answers across a record, although for different reasons. AI systems may find the correct answer in an unpreferred document where both the answer and source are equally important from a regulatory standpoint, while humans may make an accidental selection error. Additionally, due to modeling individual groups of questions independently, AI systems may supply inconsistent answers. Humans may do the same due to lack of attention to what was written previously.

The types of errors mentioned in Table 3 could be thought of as point-in-time, as they relate directly to a record that is currently being populated or updated. However, updating errors can also happen across time where answers that are evergreen, such as the date of formation of a company, could accidentally be modified. Conversely, answers that should be updated, such as the names of key employees after a change in leadership, could fail to be changed.

TABLE 3
Common Error Types
Types of errors

| Human | AI systems | Both |
|---|---|---|
| Spelling errors | Wrong/Incomplete | Wrong evidence |
| | answer predicted | document |
| | | selected |
| Failure to attach | Improper detection of | Inconsistent |
| evidence | document/table layouts | answers |
| | | across document |
| Missing values | Data corrupted during | |
| | OCR conversion | |
| Wrong option | Insensitivity to edge | |
| selected | cases and | |
| | special exceptions | |

System Output Calibration: In an exemplary embodiment, a proposed solution for system output calibration is to automate the checking of the automatic due diligence system. Using Machine Learning algorithms, the likelihood of an answer may be predicted, given both its historical- and record-level cohesiveness. Scores for cohesion may calculate the likelihood that a prediction is correct, given previous answers for the same question as well as historical changes on similar records. Record-level cohesion may use predictions from other fields on the current record. This algorithm may be used to update predictions from upstream models and to provide explanations for those updates based on common error types.

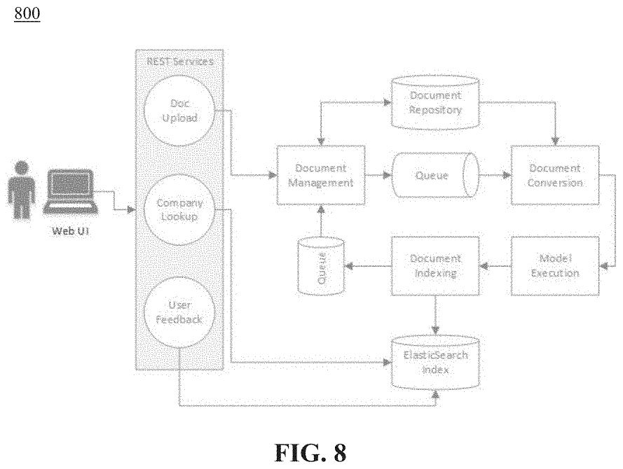

FIG. 8 is a diagram 800 that illustrates a KYC process as part of a method for automating a due diligence process for onboarding new customers with respect to KYC procedures and regulatory requirements, according to an exemplary embodiment.

Referring to FIG. 8, a KYC process starts when a user uploads a set of PDF documents through a website. In an exemplary embodiment, each document results in a message being placed on a Kafka queue to be picked up for further processing. The content of the message is an XML document that contains metadata about the file, together with workflow tracking data. The use of Kafka as a distributed queue allows for scaling of the system horizontally in order to reach throughput targets.

When the message is received, the system uses the metadata to pull the PDF document out of the document repository, and then a conversion process as described above begins. After the document is converted, the output is sent to the model endpoint over HyperText Transfer Protocol (HTTP). In an exemplary embodiment, the models are hosted in Amazon Web Services (AWS) Sagemaker, which allows for scaling to meet demand in the same way that the Kafka based components are used for scaling. The outputs of the model(s) are aggregated and sent back to the orchestration layer as a JSON object. These results are then merged with the extracted content and are stored in an ElasticSearch index as a single document. Lastly, a message is passed back via queue to the originating system indicating that the status of the request.

In an exemplary embodiment, a middle tier representational state transfer (REST) service may be implemented to serve the model results out of the index. The service also provides the capability to serve the documents out of the document repository and store and retrieve user feedback.

Platform Architecture: In an exemplary embodiment, each component of the system is deployed to a platform that suits its requirements. The web user interface (UI) is hosted on an internal cloud platform. The data orchestration layer and the REST service are hosted in a Kubernetes cluster and the models are hosted in AWS Sagemaker. Each of these platforms provide the ability to scale to meet demand.

Security: In an exemplary embodiment, because of the sensitive nature of the data in the documents, the system may use multiple layers of security to maintain integrity including any one or more of the following: 1) data encryption at rest and in transit; 2) find-grained, role-based permissions; and 3) end user and system user authentication and authorization using OAuth and Kerberos.

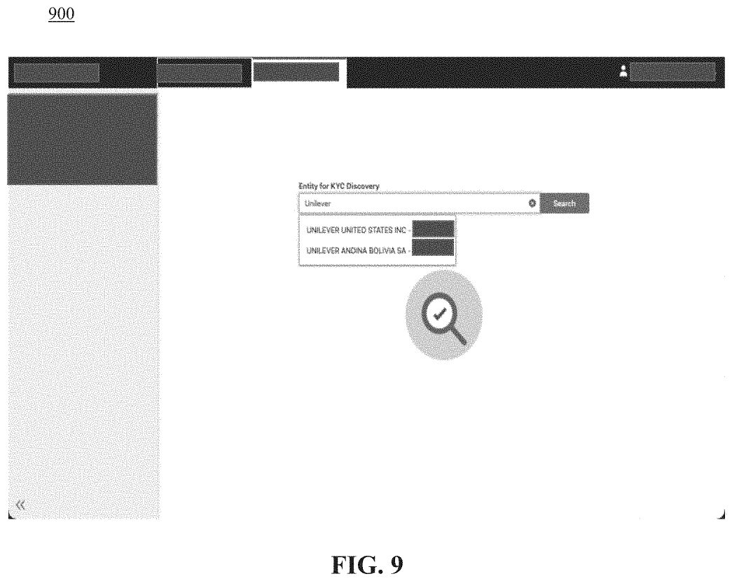

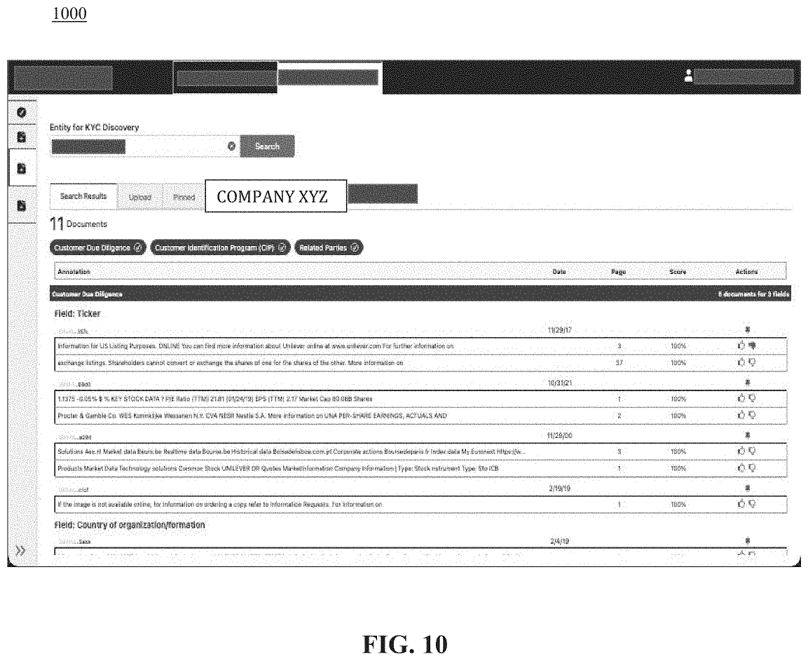

User interface: In an exemplary embodiment, a user interface is designed to facilitate easy navigation and explainability. FIG. 9 is a screenshot 900 of a graphical user interface for entering a search input as part of a method for automating a due diligence process for onboarding new customers with respect to KYC procedures and regulatory requirements, according to an exemplary embodiment. FIG. 10 is a screenshot 1000 of a graphical user interface for showing document search results as part of a method for automating a due diligence process for onboarding new customers with respect to KYC procedures and regulatory requirements, according to an exemplary embodiment.

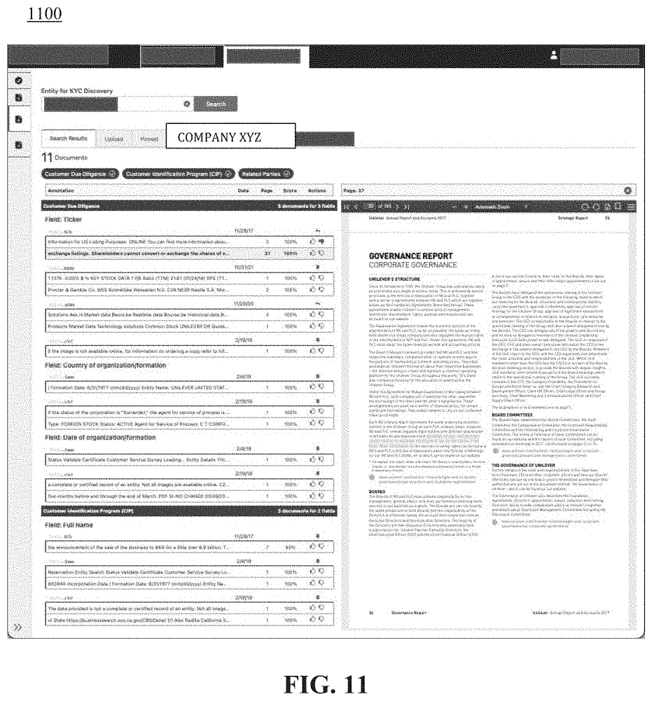

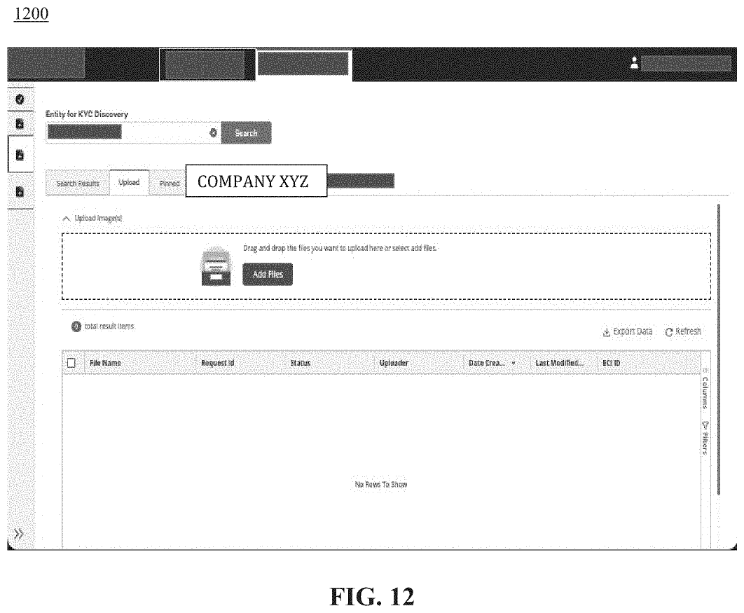

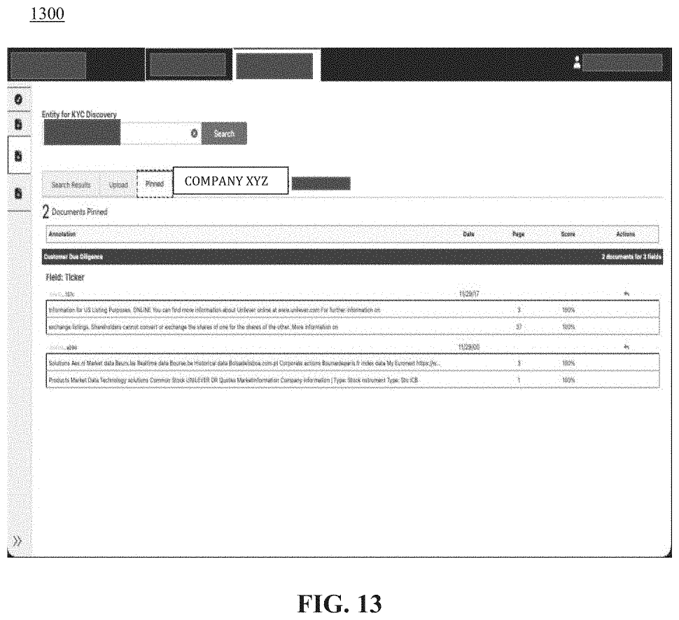

FIG. 11 is a screenshot 1100 of a graphical user interface for showing a document view as part of a method for automating a due diligence process for onboarding new customers with respect to KYC procedures and regulatory requirements, according to an exemplary embodiment. FIG. 12 is a screenshot of a graphical user interface for showing a document upload functionality as part of a method for automating a due diligence process for onboarding new customers with respect to KYC procedures and regulatory requirements, according to an exemplary embodiment. FIG. 13 is a screenshot of a graphical user interface for showing a document pinning functionality as part of a method for automating a due diligence process for onboarding new customers with respect to KYC procedures and regulatory requirements, according to an exemplary embodiment

Referring to FIG. 9, a user can begin by looking up the name or identifier for an entity, as illustrated in screenshot 900. When using name search, the UI offers lookahead options.

Referring to FIG. 10, selecting an entity leads the user to a page displaying all answers extracted from current documents belonging to the entity, as illustrated in screenshot 1000. The results are segmented according to the field. Under each field, the UI displays a list of corresponding documents and pages where the results are extracted. Each result is associated with a confidence score, the calculation of which is described above. The user is able to provide feedback by clicking on upvote/downvote buttons next to each result.

Referring to FIG. 11, clicking on each result opens a panel on the right hand side of the UI, which displays where answer was extracted from, as illustrated in screenshot 1100. The span may be highlighted in yellow to allow the user to verify the accuracy of the answer.

Referring to FIG. 12, in an exemplary embodiment, the UI may also allow the user to upload one or more documents, as illustrated in screenshot 1200. When the upload is completed, the end-to-end pipeline is triggered, which processes the documents and adds further results to the UI.

Referring to FIG. 13, in an exemplary embodiment, the UI may also allow the user to pin certain results for easy review and reuse, as illustrated in screenshot 1300.

Accordingly, with this technology, an optimized process for automating a due diligence process for onboarding new customers with respect to Know Your Customer procedures and regulatory requirements is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing a due diligence process, the method being implemented by at least one processor, the method comprising:
receiving, by the at least one processor, identification information that relates to a first customer;
selecting, from a predetermined global set of due diligence questions by the at least one processor based on the received identification information, a first group of due diligence questions to be applied to the first customer;
determining, by the at least one processor, a document source via which documents containing relevant information about the first customer are accessible;
retrieving, by the at least one processor from the document source, a first set of documents that relate to the first customer;
extracting, by the at least one processor from the first set of documents, information that is relevant to the selected first group of due diligence questions with respect to the first customer; and
outputting, by the at least one processor, the extracted information.

2. The method of claim 1, wherein the selecting of the first group of due diligence questions comprises applying, to the received identification information, a first artificial intelligence algorithm that implements a machine learning technique and is trained by using historical data that relates to an applicability of each of the predetermined global set of due diligence questions to respective customers.

3. The method of claim 1, wherein the determining of the document source comprises applying, to the received identification information, a second artificial intelligence algorithm that implements a machine learning technique and is trained by using historical document sourcing data.

4. The method of claim 3, wherein the retrieving of the first set of documents comprises applying the second artificial intelligence algorithm to the determined document source in order to identify each document included in the first set of documents.

5. The method of claim 4, wherein the extracting comprises applying, to the first set of documents, a third artificial intelligence algorithm that implements a machine learning technique and is trained by using historical semantic search data, in order to detect the information that is relevant to the selected first group of due diligence questions with respect to the first customer from within the first set of documents.

6. The method of claim 5, further comprising outputting at least one from among an output of the second artificial intelligence algorithm and an output of the third artificial intelligence algorithm that includes explanatory information that is usable for verifying at least one from among an accuracy and a reliability of the extracted information.

7. The method of claim 6, further comprising displaying, via a graphical user interface (GUI), the extracted information and the explanatory information.

8. The method of claim 1, wherein the identification information includes type information that relates to a type of the first customer, and wherein the type information includes at least one from among a first type that relates to a publicly traded corporation, a second type that relates to a privately held corporation, a third type that relates to a non-operating/asset holding company, a fourth type that relates to a fund, a fifth type that relates to a bank, a sixth type that relates to a non-banking financial institution, and a seventh type that relates to a governmental agency.

9. The method of claim 1, wherein the predetermined global set of due diligence questions includes a first subset of questions that relate to customer due diligence, a second subset of questions that relate to a customer identification program, a third subset of questions that relate to account due diligence, a fourth subset of questions that relate to product and service due diligence, a fifth subset of questions that relate to related parties, a sixth subset of questions that relate to customer ownership, a seventh subset of questions that relate to screenings and sanctions, and an eighth subset of questions that relate to financial crimes and anti-money laundering and other risks.

10. A computing apparatus for performing a due diligence process, the computing apparatus comprising:
a processor;
a memory; and
a communication interface coupled to each of the processor and the memory,
wherein the processor is configured to:
receive, via the communication interface, identification information that relates to a first customer;
select, from a predetermined global set of due diligence questions based on the received identification information, a first group of due diligence questions to be applied to the first customer;
determine a document source via which documents containing relevant information about the first customer are accessible;
retrieve, from the document source, a first set of documents that relate to the first customer;
extract, from the first set of documents, information that is relevant to the selected first group of due diligence questions with respect to the first customer; and
output the extracted information.

11. The computing apparatus of claim 10, wherein the processor is further configured to select the first group of due diligence questions by applying, to the received identification information, a first artificial intelligence algorithm that implements a machine learning technique and is trained by using historical data that relates to an applicability of each of the predetermined global set of due diligence questions to respective customers.

12. The computing apparatus of claim 10, wherein the processor is further configured to determine the document source by applying, to the received identification information, a second artificial intelligence algorithm that implements a machine learning technique and is trained by using historical document sourcing data.

13. The computing apparatus of claim 12, wherein the processor is further configured to retrieve the first set of documents by applying the second artificial intelligence algorithm to the determined document source in order to identify each document included in the first set of documents.

14. The computing apparatus of claim 13, wherein the processor is further configured to perform the extraction by applying, to the first set of documents, a third artificial intelligence algorithm that implements a machine learning technique and is trained by using historical semantic search data, in order to detect the information that is relevant to the selected first group of due diligence questions with respect to the first customer from within the first set of documents.

15. The computing apparatus of claim 14, wherein the processor is further configured to output at least one from among an output of the second artificial intelligence algorithm and an output of the third artificial intelligence algorithm that includes explanatory information that is usable for verifying at least one from among an accuracy and a reliability of the extracted information.

16. The computing apparatus of claim 15, wherein the processor is further configured to display, via a graphical user interface (GUI), the extracted information and the explanatory information.

17. The computing apparatus of claim 10, wherein the identification information includes type information that relates to a type of the first customer, and wherein the type information includes at least one from among a first type that relates to a publicly traded corporation, a second type that relates to a privately held corporation, a third type that relates to a non-operating/asset holding company, a fourth type that relates to a fund, a fifth type that relates to a bank, a sixth type that relates to a non-banking financial institution, and a seventh type that relates to a governmental agency.

18. The computing apparatus of claim 10, wherein the predetermined global set of due diligence questions includes a first subset of questions that relate to customer due diligence, a second subset of questions that relate to a customer identification program, a third subset of questions that relate to account due diligence, a fourth subset of questions that relate to product and service due diligence, a fifth subset of questions that relate to related parties, a sixth subset of questions that relate to customer ownership, a seventh subset of questions that relate to screenings and sanctions, and an eighth subset of questions that relate to financial crimes and anti-money laundering and other risks.

19. A non-transitory computer readable storage medium storing instructions for performing a due diligence process, the storage medium comprising executable code which, when executed by a processor, causes the processor to:
receive identification information that relates to a first customer;
select, from a predetermined global set of due diligence questions based on the received identification information, a first group of due diligence questions to be applied to the first customer;
determine a document source via which documents containing relevant information about the first customer are accessible;
retrieve, from the document source, a first set of documents that relate to the first customer;
extract, from the first set of documents, information that is relevant to the selected first group of due diligence questions with respect to the first customer; and
output the extracted information.

20. The storage medium of claim 19, wherein when executed, the executable code further causes the processor to select the first group of due diligence questions by applying, to the received identification information, a first artificial intelligence algorithm that implements a machine learning technique and is trained by using historical data that relates to an applicability of each of the predetermined global set of due diligence questions to respective customers.
